(19) United States
(12) Patent Application Publication
(10) Pub. No.: US 2026/0233590 A1
(43) Pub. Date: Aug. 13, 2026

(54) OVERHEAD DOOR SYSTEM

(71) Applicant: Transglobal, Inc., Warren, OH (US)

(72) Inventors: Patrick Alan PELPHREY, Galion, OH (US); John Thomas HAAN, Findlay, OH (US); Scott Adam RUDER, Lebanon, IN (US); James Bruce BROWN, Crystal Lake, IL (US)

(21) Appl. No.: 19/444,452

(22) Filed: Jan. 9, 2026

Related U.S. Application Data
(60) Provisional application No. 63/743,766, filed on Jan. 10, 2025.

(51) Int. Cl. B60J 5/14

(52) U.S. Cl. CPC B60J 5/14

(57) ABSTRACT

An overhead door system may have at least one door post portion. The at least one door post portion may have a recessed portion with a track portion.

### FIELD

A device that relates to an overhead door system is depicted and described.

### BACKGROUND

The present disclosure may be employed to support a rolling, overhead door, instead of a traditional, swing-open, two-door system. Both types of door systems have their advantages and disadvantages. One disadvantage of an overhead door is that it provides an opening between track portions that is smaller than the opening between track portions of a swing-open door system. Specifically, the opening between the track portions of a swing-open door system is about 98 inches wide, while prior art overhead door systems offer an opening that is significantly narrower at 93 inches wide. One reason for this is the prior art side door post portions are approximately 4.5 inches wide each. The presently disclosed device offers a way to utilize an overhead door while also providing a 98-inch-wide opening in a trailer. Such an outcome may be accomplished by providing a door post with a recessed portion.

Another disadvantage of overhead door systems is that they provide a smaller vertical opening than the vertical openings provided by a traditional, swing-open, two door system. The reason for this is that a typical overhead door requires room above the door to accommodate a counterbalance that helps to operate (i.e. overcome the weight of the door). To solve this problem, in a further embodiment, the counterbalance is removed from this area and an offset header may be employed to provide vertical clearance and to lock the door in a closed position.

### SUMMARY

An overhead door system may have at least one door post portion. The door post portion may have a recessed portion with a track portion.

The door post portion may be connected to a side wall of a trailer.

An upper portion of the track portion may be attached to a first wall of the recessed portion.

The recessed portion may have a mounting bracket.

The mounting bracket may be attached to a second wall and a third wall of the recessed portion.

A middle portion and a lower portion of the track portion may be attached to the mounting bracket.

The overhead door system may have a header, the header may have a sealing portion with a sealing surface, and the sealing surface may be adapted to seal with a door.

When the door is in a closed position, upward movement of the door may be blocked by a horizontal portion of the header.

An overhead door system may have at least one door post portion. The at least one door post portion may have a recessed portion and a bumper portion.

The recessed portion may be longitudinally between a bumper portion and a width portion of the at least one door post portion.

The at least one door post portion may have an inner door post portions and an outer track portion.

The inner door post portions may have the bumper portion and the recessed portion, and the outer door post portion may have the width portion.

The overhead door system may have two door post portions with an opening between the door post portions.

The width portion may extend laterally further into the opening than the bumper portion.

The overhead door system of claim 10, wherein a door is adapted to move within the recessed portion of the at least one door post portion.

The overhead door system may have at least one door post portion, and the at least one door post portion may have a housing portion and a connecting portion. The housing portion may have a recessed portion.

The overhead door system may have a first wall, a second wall, and a third wall.

The overhead door system may also have an adaptor portion, and the adaptor portion may be connected to a lateral face of the inside of the trailer.

At least a portion of the recessed portion may be in direct facing contact with at least a portion of the adaptor portion.

The overhead door system may also have a door which may be movable within the at least one door post portion.

### BRIEF DESCRIPTION OF THE DRAWINGS

FIG. 1 is a schematic perspective view of a trailer with an overhead door system in a fully closed position;

FIG. 2 is a schematic perspective view of a trailer with an overhead door system in a half-open position;

FIG. 3 is a schematic perspective view of a trailer with an overhead door system in a fully open position;

FIG. 4 is a schematic view of a side post of an overhead door system;

FIG. 5 is a schematic view of a side post with a roller and a door panel of an overhead door system;

FIG. 6 is a schematic view of a side post with a roller and a door panel of an overhead door system;

FIG. 7 is a schematic perspective view of an overhead door system;

FIG. 8 is a schematic view of a side post with a roller and a door panel of an overhead door system;

FIG. 9 is a schematic view of a side post with a roller and a door panel of an overhead door system;

FIG. 10 is a schematic view of a side post with a roller and a door panel of an overhead door system.

FIG. 11 is a schematic view of a side post with a roller and a door panel of an overhead door system.

### DETAILED DESCRIPTION

It is to be understood that the presently disclosed subject matter may assume various alternative orientations and step sequences, except where expressly specified to the contrary. It is also to be understood that the presently disclosed subject matter described in the following specification is simply an exemplary aspect. Hence, specific dimensions, directions, or other physical characteristics relating to the aspects disclosed are not to be considered as limiting, unless expressly stated otherwise.

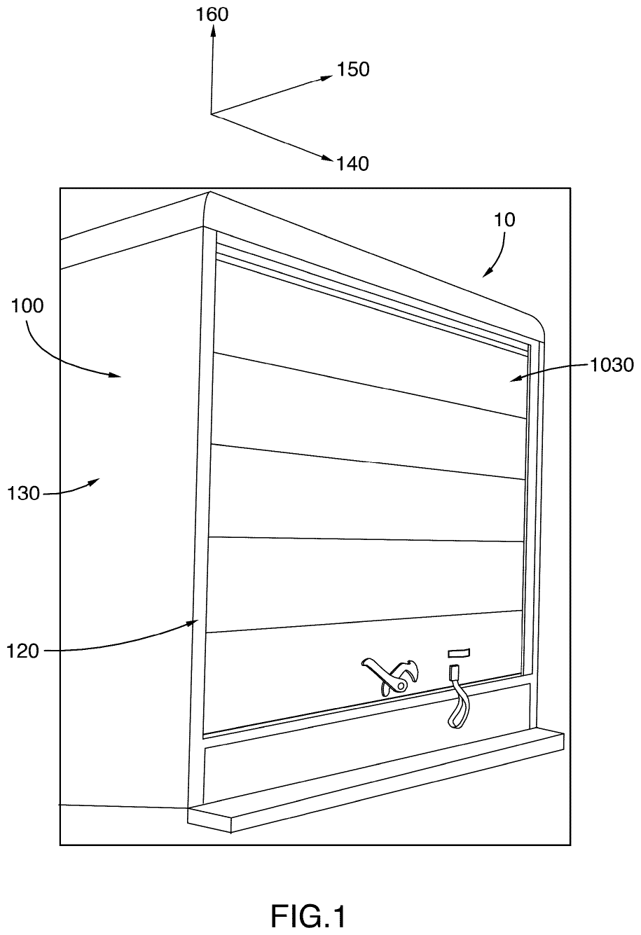

As shown in FIG. 1, the present disclosure may be employed in an environment 10 such as a semi-truck trailer, a truck body, or a container. The environment 10 will hereinafter be referred to as a trailer 10, but applications outside of a trailer 10 are possible.

In one embodiment of an overhead door system 70, the system 70 may comprise at least one door post portion 40. By way of example, the overhead door system 70 may comprise two door post portions 40 that may be substantially parallel and planar to one another. The door post portions 40 may be separated by a substantially constant distance that may define an opening 30. Each door post portion 40 may comprise a track portion 80, a mounting bracket 90, and a movable, roll-up door 20 between the track portions 40. While a movable, roll-up door 20 is mentioned and described herein, the overhead door system 70 may comprise any door desired. As each door post portion 40 may be substantially similar, only one of the door post portions 40 will be described.

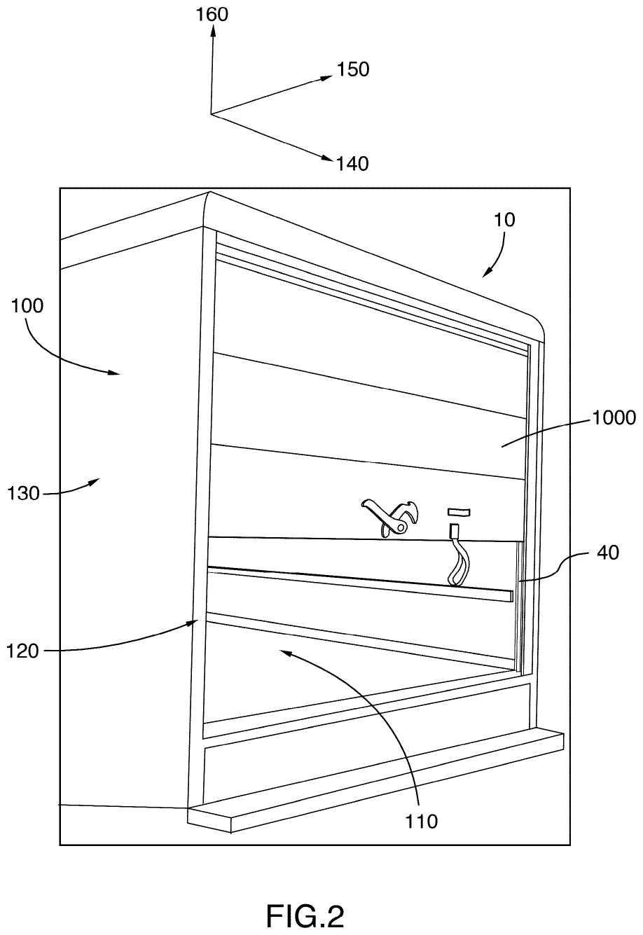

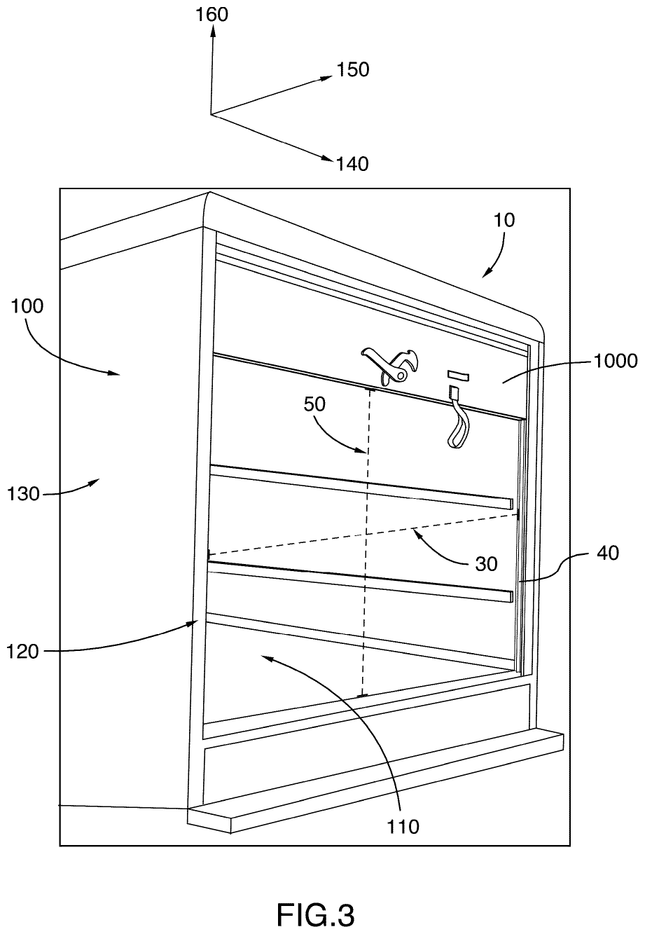

As shown in FIGS. 2-3, in one embodiment, the door post portion 40 may be connected to, such as mounted on side walls 100 of a trailer 10, which may comprise an inside portion 110, an end portion 120, and an outside portion 130. The door post portion 40 may be permanently mounted to the side walls 100, such as through a weld, or the door post portion 40 may be selectively mounted to the side walls 100, such as through mechanical fasteners. While a weld and mechanical fasteners are mentioned, the door post portion 40 may be attached to the side walls 100 via any means necessary to achieve the desired connection.

The trailer 10 may have a length as its largest dimension that typically extends in the forward and rear driving direction of the trailer 10, which will be its longitudinal extension 140. The width of the trailer 10 will be its lateral extension 150, and the height of the trailer 10 will be the vertical extension 160. The lateral extension 150 is generally transverse the longitudinal extension 140 and the vertical extension 160 is generally transverse the longitudinal extension 140 and lateral extensions 150.

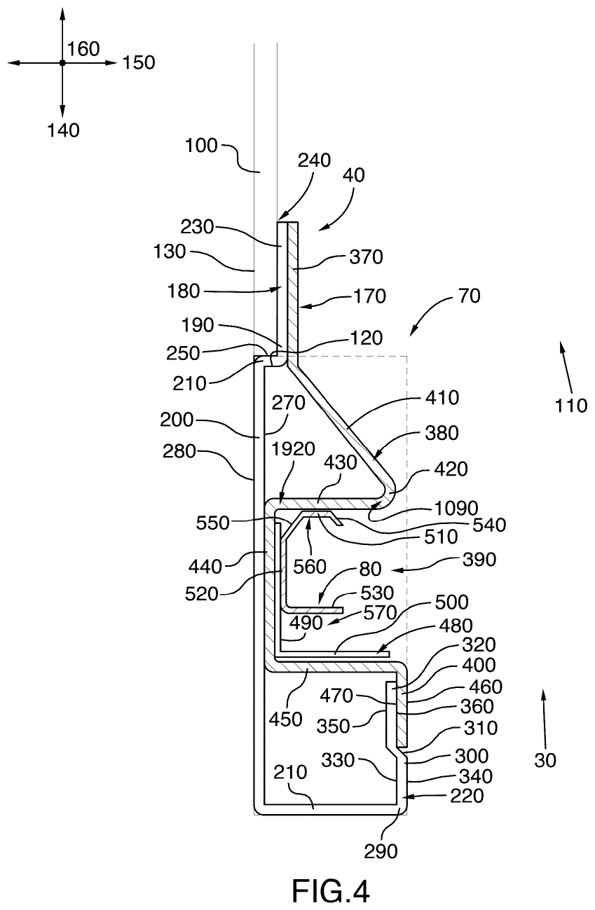

Turning now to FIG. 4, each door post portion 40 may comprise an inner door post portion 170 and an outer door post portion 180. While an inner door post portion 170 and an outer door post portion 180 are mentioned, the door post portions 170, 180 may be one piece, unitary and integrally formed, or they may be two or more pieces that are connected together such as through welding, adhesives and/or mechanical fasteners. The inner 170 and outer 180 door post portions may be constructed of metal, composite materials, plastics and/or other materials capable of withstanding the harsh outdoor environment of a trailer 10. In some cases, the inner 170 and outer 180 door post portions may each have a substantially constant cross-sectional wall thickness.

The outer door post portion 180 may comprise a first connector portion 190, a long portion 200, a width portion 210, and a second connector portion 220. The first connector portion 190 may be L shaped and may be attached to the inside portion 110 and the end portion 120 of the side wall. A first long leg 230 of the first connector portion 190 may be in direct facing contact with the side wall 100 thus slightly increasing the width of the side wall 100 at the attachment location 240. A second short leg 250 of the first connector portion 190 may be in direct facing contact with the trailer end portion 120. The attachment may be any that secures the first connector portion 190 to the side wall 100, but by way of example, the attachment may be achieved via welding, adhesives, and/or mechanical fasteners.

The first connector portion 190 may transition to the long portion 200. The transition may be such as a first radiused corner 210. The radius angle may be such as approximately 90 degrees.

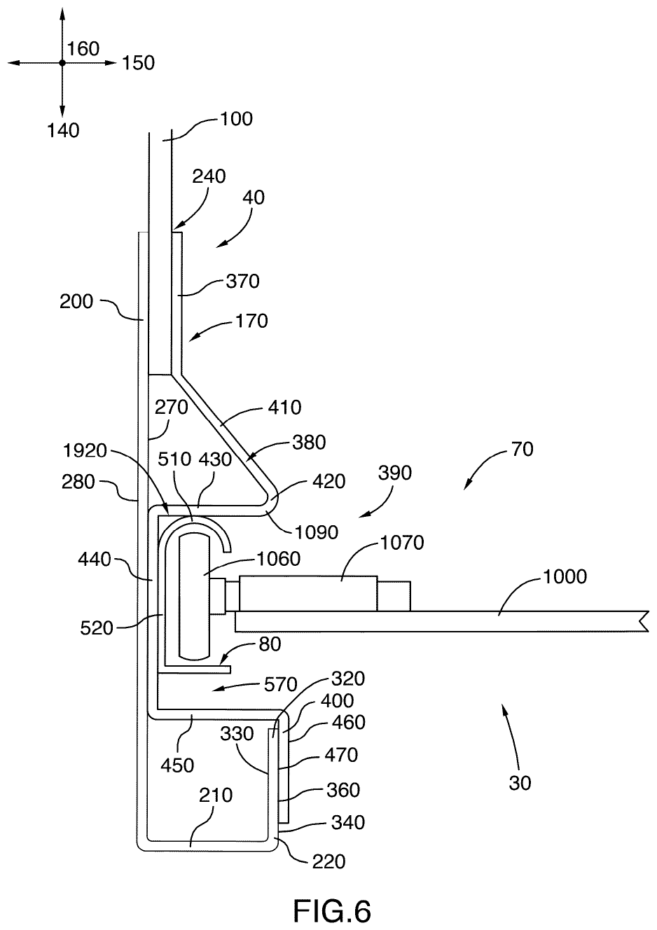

The long portion 200 may comprise an inner edge 270 and an outer edge 280. The long portion 200 may extend away from the side wall 100 to which it is attached in a manner such that the outer edge 280 of the long portion 200 and the outside portion 130 of the trailer 10 may be parallel and planar. In other words, the long portion 200 may serve as a longitudinal extension of the side wall 100 to which the track portion 80 is attached. In some embodiments, the long portion 200 may be approximately 6 inches long. While an extension of the side wall 100 is mentioned, the outer door post portion 180 may not comprise the first connector portion 190, and instead the long portion 200 may attached to the outside portion 130 of the trailer 10, as shown in FIG. 6.

The long portion 200 may transition to the width portion 210. The transition may be such as a radiused corner. The radius angle may be approximately 90 degrees. The width portion 210 may extend perpendicularly from the long portion 200 laterally towards the other door post portion 40 and may be planar and of constant thickness. The width portion may be between 1.5 and 2.5 inches wide.

The width portion 210 may transition to the second connector portion 220. The transition may be such as a second radiused corner 290. The radius angle may be approximately 90 degrees. The second connector portion 220 may comprise a first portion 300, a second portion 310, and a third portion 320. The first portion 300 may extend perpendicularly from the width portion 210 longitudinally into the trailer 10 and may be parallel to the long portion 200. The first portion 300 may comprise an outer wall 330 that faces laterally towards the long portion 200 and an inner wall 340 that faces laterally away from the long portion 200.

The first portion 300 may transition to the second portion 310. The second portion 310 may be angled towards the long portion 200 at between approximately 10 degrees and approximately 80 degrees. In some cases, the second portion 310 may extend between the first 300 and third 320 portions at approximately 45 degrees. The second portion 310 may be between approximately 1/10^{th} and approximately ⅓^{rd} the length of either the first 300 or third 320 portions.

The second portion 310 may transition to the third portion 320. The third portion 320 may comprise an outer wall 350 that laterally faces towards the long portion 200 and an Inner wall 360 that laterally faces away from the long portion 200. The third portion 320 may be slightly laterally closer to the long portion 200 than the first portion 300 of the second connector portion 220 is, such as by a width of the first portion 300. The second connector portion 220 may be between approximately 1/10^{th} and approximately ⅓^{rd} the length of the long portion 200.

The inner door post portions 170 may comprise a first connector portion 370, a bumper portion 380, a recessed portion 390, and a second connector portion 400. The first connector portion 370 of the inner door post portion 170 may be of similar length to and may be attached to (such as in direct facing contact along their respective longitudinal lengths), the first connector portion 190 of the outer door post portion 180. The attachment may be any that secures the first connector portion 370 of the inner door post portions 170 to the first connector portion 190 of the outer door post portion 180, but by way of example, the attachment may be achieved via welds, adhesives, and/or any mechanical fasteners.

The first connector portion 370 of the inner door post portion 170 may transition to the bumper portion 380. The bumper portion 380 may comprise an angled edge 410. The angled edge 410 may angle laterally away from the long portion 200 of the outer door post portion 180 by between approximately 25 and approximately 80 degrees. By way of example, the angle may be such as approximately 45 degrees. The angled edge 410 may extend laterally away from the long portion 200 but may not extend laterally beyond the width portion 210 of the outer door post portion 180.

In some cases, the bumper portion 380 serves to protect the recessed portion 390 and/or its contents. The recessed portion 370 may be longitudinally between the bumper portion and the width portion of the at least one door post portion. For example, cargo (not depicted) moving within the inside portion 110 of the trailer 10 has a tendency to roll along the inside portion 110 of the trailer 10 and contact the side wall 100. The bumper portion 380 deflects the cargo (not depicted) from entering into the recessed portion 390, which may damage the cargo and/or its contents.

The width portion 210 of the outer door post portion 180 also functions in the same way, but often it may protect the recessed portion 390 and/or its contents from vehicles (not depicted) and their loads (not depicted) approaching the trailer 10 from the outside. By way of example, the width portion may extend laterally further into the opening 30 than the bumper portion 380 does.

The angled edge 410 may transition laterally outward to the recessed portion 390. The transition may be such as through a third radiused corner 420 of between approximately 30 degrees and approximately 90 degrees.

The recessed portion 390 may comprise a first wall 430, a second wall 440, and a third wall 450. A first edge portion 1090 of the first wall 430 may extend away from the angled edge 410 laterally towards, and perpendicularly to, the long portion 200 of the outer door post portion 180. The first wall 430 may extend laterally generally the length of the width portion 210 of the outer door post portion 180.

A second edge portion 1970 of the first wall 430 may transition to the second wall 440 of the recessed portion 390. The transition may be such as an approximately 90 degree radiused transition. The second wall 440 may be perpendicular to the first wall 430 and may extend away from the first wall 430 along the long portion 200 of the outer door post portion 180 toward the width portion 210 of the outer door post portion 180. The second wall 440 may run parallel to, and be in direct facing contact with, the long portion 200 of the outer door post portion 180. The second wall 440 may be directly attached to the long portion 200 of the outer door post portion 180 along the length of the second wall 440. The attachment may be achieved by any means necessary to secure the second wall 440 to the long portion 200, but by way of example, the attachment may be via welding, adhesives, and/or mechanical fasteners. By way of further example, the second wall 440 of the inner door post portion 170 may contact the long portion 200 of the outer door post portion 180 without being secured to the long portion 200 of the outer door post portion 180.

The second wall 440 of the recessed portion 390 may transition to the third wall 450 of the recessed portion 390. The transition may be such as an approximately 90 degree radiused transition. The third wall 450 may extend laterally away from the second wall 440 and the long portion 200 of the outer door post portion 180. The third wall 450 may be perpendicular to the second wall 440 of the recessed portion 390 and may be parallel to the first wall 430 of the recessed portion 390. The third wall 450 may extend away from the second wall 440 but may not extend laterally further towards the other side wall 100 than the width portion 210 of the outer door post portion 180. In some embodiments, the first wall 430 and the third wall 450 may be approximately laterally matched with one another.

The third wall 450 of the recessed portion 390 may transition to the second connector portion 400. The transition may be such as through an angled radiused corner of between approximately 45 and approximately 120 degrees. The second connector portion 400 of the inner door post portion 170 may extend perpendicularly away from the third wall 450 of the recessed portion 390 longitudinally towards the width portion 210 of the outer door post portion 180. The second connector portion 400 may comprise an inside edge 460 and an outside edge 470. The outside edge 470 of the second connector portion 400 of the inner door post portion 170 may be adapted to attach to the inner wall 360 of the third portion 320 of the second connector portion 220 of the outer door post portion 180. The connection may be achieved by any means necessary to secure the second connector portion 400 of the inner door post portion 170 to the second connector portion 220 of the outer door post portion 180, but by way of example, the connection may be achieved through welding, adhesives, and/or mechanical fasteners. The inside edge 470 of the second connector portion 400 of the inner door post portion 170 may be parallel and planar to the inner wall 340 of the first portion 300 of the second connector portion 220 of the outer door post portion 180. In some cases, the connection may be a direct facing connection along the longitudinal lengths of the second connector portions 400, 220 of the inner and outer door post portions 170, 180. In other words, neither the outside edge 470 of the second connector portion 400 of the inner door post portion 170 nor the inner wall 340 of the first portion 300 of the second connector portion 220 of the outer door post portion 180 may protrude further into the opening 30 defined by the two door post portions 40 than the other.

The recessed portion 390 of the inner door post portion 170 may comprise a mounting bracket 480. The mounting bracket 480 may be L-shaped with a first leg 490 and a second leg 500, and the respective legs 490, 500 of the mounting bracket 480 may be respectively and directly attached to the second and third walls 440, 450 of the recessed portion 390. The connection may be achieved by any means necessary to secure the mounting bracket 480 to the second and third walls 440, 450, but by way of example, the connection may be achieved by welding, adhesives, and/or mechanical fasteners. The mounting bracket 480 may be completely contained within the recessed portion 390. In other words, the mounting bracket 480 may not protrude out of the recessed portion 390. While a mounting bracket 480 is mentioned, in another embodiment, the overhead door system 70 may not comprise a mounting bracket 480.

Attached to the mounting bracket 480 may be the track portion 80. The track portion 80 may comprise an upper portion 510, a middle portion 520, and a lower portion 530. The upper portion 510 of the track portion 80 may be attached to the first wall 430 of the recessed portion 390. While the connection may be achieved by any means necessary to secure the track portion 80 to the first wall 430, by way of example, the connection may be achieved via welding, adhesives, and/or mechanical fasteners. While a secured connection between the first wall 430 of the recessed portion 390 and the upper portion 510 of the track portion 80 is mentioned, it may be the case that the upper portion 510 of the track portion 80 and the first wall 430 of the recessed portion 390 are in contact with one another but not secured to one another. By way of further example, the upper portion 510 of the track portion 80 and the first wall 430 of the recessed portion 390 may not be in contact at all.

In some embodiments the upper portion 510 may be generally arc or concave shaped. The upper portion 510 may be comprised of an inner portion 540, an outer portion 550 and a central portion 560 bounded between the inner and outer portions 540, 550. As shown in FIGS. 4-6, the central portion 560 may be attached to the first wall 430. The inner and outer portions 540, 550 may extend from the central portion 560 and may not be in contact with the first wall 430. The arc shape of the upper portion 510 may assist in retaining a wheel 1060, or a series of wheels 1060 therein.

The middle portion 520 of the track portion 80 may be directly attached to the mounting bracket 480. The connection may be such that the middle portion 520 is in direct facing contact with the mounting bracket 480 along the length of the middle portion 520. While this connection may be achieved via any means necessary to secure the track portion 80 to the mounting bracket 480, by way of example, this connection may be achieved via welding, adhesives, and/or mechanical fasteners. While a connection between the mounting bracket 480 and the middle portion 520 of the track portion 80 is mentioned, it may be the case that the middle portion 520 of the track portion 80 and the mounting bracket 480 are in contact with one another but not secured to one another. The middle portion 520 may extend in the longitudinal direction with enough longitudinal length to accommodate a wheel or roller 1060 therein.

In one embodiment, the lower portion 530 of the track portion 80 may be cantilevered from the middle portion 520 of the track portion 80. The lower portion 530 may extend laterally from the middle portion 520 at approximately 90 degrees. In another embodiment, the lower portion 530 of the track portion 80 may be attached to the mounting bracket 480. This connection may be achieved by any means necessary to secure the lower portion 530 of the track portion 80 to the mounting bracket 480, but by way of example, this connection may be achieved via welding, adhesives, or mechanical fasteners. While a connection between the mounting bracket 480 and the lower portion 530 of the track portion 80 is mentioned, it may be the case that the lower portion 530 of the track portion 80 and the first wall 430 of the recessed portion 390 are in contact with one another but not secured to one another. By way of further example, as shown in FIGS. 4-6, the lower portion 530 of the track portion 80 and the mounting bracket 480 may not be in contact at all. Instead, they may be separated by a gap 570.

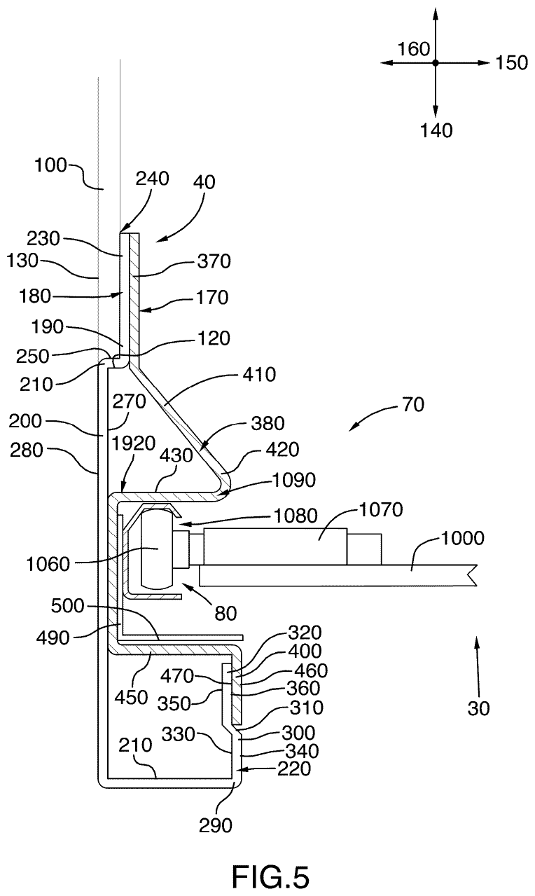

The upper, middle, and lower portions 510, 520, 530 may be designed to accommodate one or more wheels or rollers 1060 therein for the overhead door 20, one embodiment of which is schematically depicted in FIGS. 5-6. The wheels/rollers 1060 may be selectively located in a C-shape formed by the upper, middle, and lower portions 510, 520, 530 with axles 1070 for the wheels/rollers 1060 extending laterally through an opening 1080 created between the upper and lower portions 510, 530.

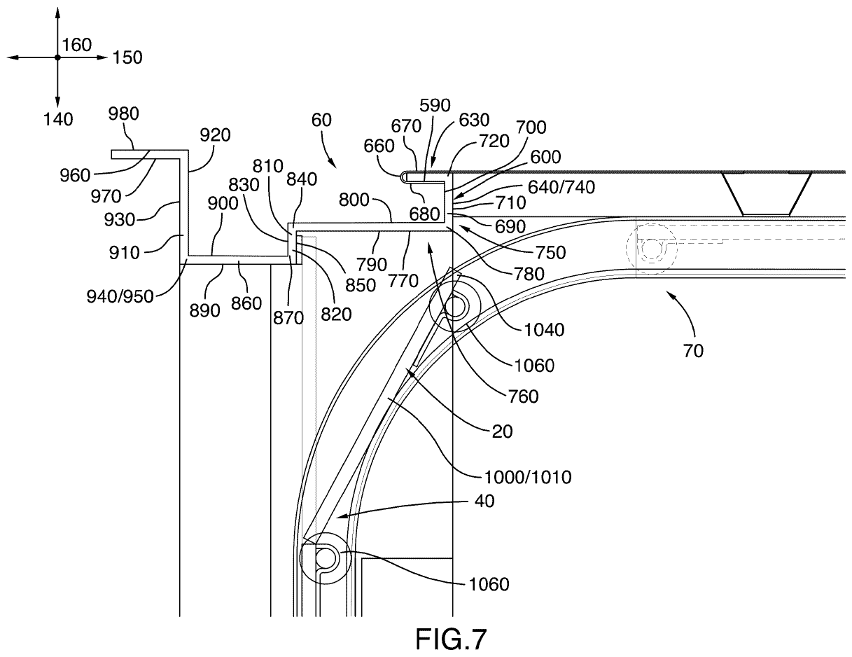

The offset header 60, depicted in FIG. 7, may have a first portion 590. The first portion 590 of the offset header 60 may be one piece, unitary, and integrally formed. The first portion 590 may also have a constant thickness between an inner wall 600 and an outer wall 610. The first portion 590 of the offset header 60 may be such as a lip 590 that may be attached to a top portion 620 of the trailer 10 via a connecting sheet 630. The top portion 620 of the trailer 10 may have a constant thickness. The top portion 590 may comprise a short edge 640 and a long edge 650. The short edge 640 of the top portion 620 may be connected to the long edge 650. The short edge 640 may extend generally transverse the long edge 650.

The connecting sheet 630 may extend longitudinally and laterally beyond the top portion 620. The connecting sheet 630 may extend far enough longitudinally out of the top portion of the trailer 10 such that the connecting sheet 630 may wrap around an end portion 660 of the first portion 590 of the offset header 60, such that the connecting sheet 630 may contact both a top portion 670 and a bottom portion 680 of the first portion 590 of the offset header 60. The connecting sheet 630 may then be secured, in a wrapped position, to the first portion 590 of the offset header 60. In one embodiment, the connecting sheet 630 may be secured to the first portion 590 of the offset header 60 via a rivet (not depicted). While a rivet is mentioned, the connecting sheet 630 may be secured to the first portion 590 of the offset header 60 via welding, adhesives, or mechanical fasteners.

The first portion 590 of the offset header 60 may be cantilevered from a second portion 690 of the offset header 60. The second portion 690 of the offset header 60 may be one piece, unitary, and integrally formed. The second portion 690 of the offset header 60 may have a constant thickness between an inner wall 700 and an outer wall 710. The first portion 590 may be cantilevered from an upper end portion 720 of the second portion 690. The second portion 690 of the offset header 60 may be perpendicular to the first portion 590 of the offset header 60 and may be parallel to the short edge 640 of the top portion 620 of the trailer 10. The second portion 690 of the offset header 60 may have the inner wall 700 that directly abuts an outer surface 740 of the short edge 640 of the top portion 620 of the trailer 10 without any intervening structures. The attachment may be achieved by any means necessary to secure the second portion 690 of the offset header 60 to the short edge 640 of the top portion 620 of the trailer 10, but by way of example, the attachment may be achieved via welding, adhesives, and/or mechanical fasteners. The second portion 690 of the offset header 60 may have a slightly greater height than the height of the short edge 640 of the top portion 670 of the trailer 10, thus creating a vertical offset 750 between the second portion 690 of the offset header 60 and the top portion 620 of the trailer 10.

The second portion 690 of the offset header 60 may transition to a sealing portion 760 of the offset header 60. The sealing portion 690 of the offset header 60 may comprise a horizontal portion 770 that may be cantilevered from a lower end portion 780 of the second portion 690 of the offset header 60. The horizontal portion 770 may be one piece, unitary, and integrally formed. The horizontal portion 770 may have a constant thickness between an inner wall 790 and an outer wall 800. The sealing portion 760 may also have a vertical portion 810 that may be one piece, unitary, and integrally formed, and may also have a constant thickness between an inner wall 820 and an outer wall 830. The vertical portion 810 may extend downwards from the horizontal portion 770 at an approximately 90-degree angle and at an end 840 of the horizontal portion 770 that is longitudinally distal from the second portion 690. The sealing portion 760 may further comprise a seal 850 that may be attached to a side of the vertical portion 810 that is laterally closer in distance to the top portion 620 of the trailer 10. By way of example, the seal 850 may be on the inner wall 820 or the outer wall 830 of the vertical portion 810.

A third portion 860 of the offset header 60 may be cantilevered at a first end portion 870 of the third portion 860 of the offset header 60 from an end portion 880 of the vertical portion 810 of the sealing portion 760 of the offset header 60. The third portion 860 of the offset header 60 may be one piece, unitary, and integrally formed. The third portion 860 of the offset header 60 may have a constant thickness between an inner wall 890 and an outer wall 900. The third portion 860 may be parallel to the second portion 690 and vertical portion 810 of the offset header 60.

The third portion 860 of the offset header 60 may transition to a fourth portion 910 of the offset header 60. The fourth portion 910 of the offset header 60 may be one piece, unitary, and integrally formed. The fourth portion 910 of the offset header 60 may have a constant thickness between an inner wall 920 and an outer wall 930. The fourth portion 910 of the offset header 60 may extend perpendicularly from a first end portion 940 of the fourth portion 910 of the offset header 60 from a second end portion 950 of the third portion 860 of the offset header 60. The fourth portion 910 of the offset header 60 may be parallel to the vertical portion 810 of the offset header 60. The fourth portion 910 may extend upwards, vertically towards the top portion 620 of the trailer 10. In other words, the fourth portion 910 of the offset header 60 may be perpendicular to the long edge 650 of the trailer 10. The fourth portion 910 of the offset header 60 may extend vertically above the top portion 620 of the offset header 60.

The fourth portion 910 of the offset header 60 may transition to a fifth portion 960 of the offset header 60. The fifth portion 960 of the offset header 60 may be one piece, unitary, and integrally formed. The fifth portion 960 of the offset header 60 may have a constant thickness between an inner wall 970 and an outer wall 980. The fifth portion 960 of the offset header 60 may be cantilevered from a second end portion 990 of the fourth portion 910 of the offset header 60. The fifth portion 960 of the offset header 60 may be perpendicular to the fourth portion 910 of the offset header 60 and may be parallel to the third portion 860 of the offset header 60.

The offset header 60 may be adapted to lock the overhead door 20 in place as follows: as the overhead door 20, which may be comprised of a plurality of panels 1000 that may be pivotably attached to one another, is being pulled along the horizontal track portion 80 of the at least one door post portion 40, which the overhead door 20 may be adapted to move within, a top panel 1010 may begin to rotate from a horizontal position 1020 to a vertical position 1030. Upon entering the vertical position 1030, the top panel 1010, such as an upper edge portion 1040 of the top panel 1010, may contact the seal 850 that rests in the sealing portion 760 of the offset header 60. Due to the vertical offset 750 created by the offset header 60, from this position, the top panel 1010 may be in contact with both the seal 850 and the horizontal portion 770 of the offset header 60, thus locking the overhead door 20 in place. In other words, when in a closed position, upward movement of the overhead door 20 may be blocked by the horizontal portion 770 of the offset header 60. To transition the overhead door 20 from a locked position to an unlocked position, any means that maintains the vertical opening 50 of the trailer 10 may be used, but by way of example, an unlocking mechanism (not depicted) may be such as a spring system, mechanical linkage, electrical actuator and/or a hydraulic/pneumatic actuation system, which pulls the top panel from the vertical position back into an angled position allowing the door to open (i.e. unlock).

In another aspect, at least one door post portion 1100 may comprise a connecting portion 1110, also known as a bumper portion 1100, a housing portion 1120, and an adaptor portion 1130. While at least one door post portion 1100 is mentioned, there may be two door post portions 1100 with an opening 1140 between the two door post portions 1100.

The housing portion 1120 may comprise the recessed portion 390, which may comprise the first wall 430, the second wall 440, and the third wall 450 as before. The housing portion 1120 may further comprise a first attachment portion 1150 and a second attachment portion 1160.

The first attachment portion 1150 may extend from the first edge portion 1090 of the first wall 430 of the recessed portion 390 at an approximately 90-degree angle. The first attachment portion 1050 of the housing portion 1120 may be generally parallel to the side wall 100 to which the door post portion 1100 is attached.

The second attachment portion 1160 may comprise a first portion 1170, a second portion 1180, and a third portion 1190. A first edge portion 1200 of the first portion 1170 of the second attachment portion 1160 may extend from a first edge portion 1210 of the third wall 450 of the recessed portion 390 at an approximately 90-degree in a direction opposite of the first wall 430 of the recessed portion 390. The first portion 1170 of the second attachment portion 1180 may be planar and may be parallel to the side wall 100.

A second edge portion 1220 of the first portion 1170 of the second attachment portion 1160 may transition to the second portion 1180 of the second attachment portion 1160. The second portion 1180 of the second attachment portion 1160 may extend away from the first portion 1170 of the second attachment portion 1160 at an angle of between approximately 100-degrees and approximately 170-degrees. The second portion 1180 may be planar and may transition to the third portion 1190 of the second attachment portion 1160.

The third portion 1190 of the second attachment portion 1160 may extend away from the second portion 1180 of the second attachment portion 1160 laterally towards the sidewall 100. The third portion 1190 may be generally planar and may be parallel to the third wall 450 of the recessed portion 390.

The connecting portion 1110 of the door post portion 1100 may comprise a first mating portion 1230, a transition portion 1240, and a second mating portion 1250. The first mating portion 1230 may comprise an inner surface portion 1260 and an outer surface portion 1270. At least a portion of the inner surface portion 1260 of the first mating portion 1230 may be in direct facing contact with at least a portion of an outer surface portion 1280 of the first attachment portion 1150 of the housing portion 1120 of the door post portion 1100. The first mating portion 1230 of the connecting portion 1110 and the first attachment portion 1150 of the housing portion 1120 may be attached to one another. The attachment may be achieved by any means necessary to secure the first mating portion 1230 to the first attachment portion 1150, but by way of example, the attachment may be achieved by a weld, a snap fit, a form fit, or mechanical fasteners. While an attachment of the first mating portion 1230 of the connecting portion 1110 and the first attachment portion 1150 of the housing portion 1120 is mentioned, it may be the case that the connecting portion 1110 and the housing portion 1120 are once piece and integrally formed.

The first mating portion 1230 of the connecting portion 1110 may transition to the transition portion 1240. The transition portion 1240 may extend laterally towards the side wall 100 and longitudinally towards the inside portion 110 of the trailer 10 at an angle of between approximately 20 degrees and approximately 80 degrees. While an angle of between approximately 20 degrees and approximately 80 degrees is mentioned, the transition portion 1240 may extend towards the side wall 100 at any desired angle. The transition portion 1240 may be planar and may extend laterally outwards towards the side wall 100 such that an outer edge portion 1290 of the transition portion 1240 may be laterally closer to the side wall 100 than the second wall 440 of the recessed portion 390 is.

The transition portion 1240 may transition to the second mating portion 1250 of the connecting portion 1110. The transition from the transition portion 1240 to the second mating portion 1250 may be such as a radiused corner 1300. The second mating portion 1250 may extend away from the transition portion 1240 such that the second mating portion 1250 may be generally parallel to the side wall 100. The second mating portion 1250 may extend longitudinally away from the inside portion 110 of the trailer 10. The second mating portion 1250 may also be generally parallel to the first attachment portion 1150 of the housing portion 1120. The second mating portion 1250 may be of any length necessary to fit the needs of the application, but by way of example, the second mating portion 1250 may have a greater length than a length of the first attachment portion 1150 of the housing portion 1120.

The adaptor portion 1130 of the door post portion 1100 may comprise a box portion 1310 with a first short side 1320, a second short side 1330, a first long side 1340, and a second long side 1350. The box portion 1310 may be generally rectangular. While a generally rectangular box portion 1310 is mentioned, the box portion 1310 does not necessarily need to be a perfect rectangle and may comprise angled, curved, contoured, or non-planar sides or corners.

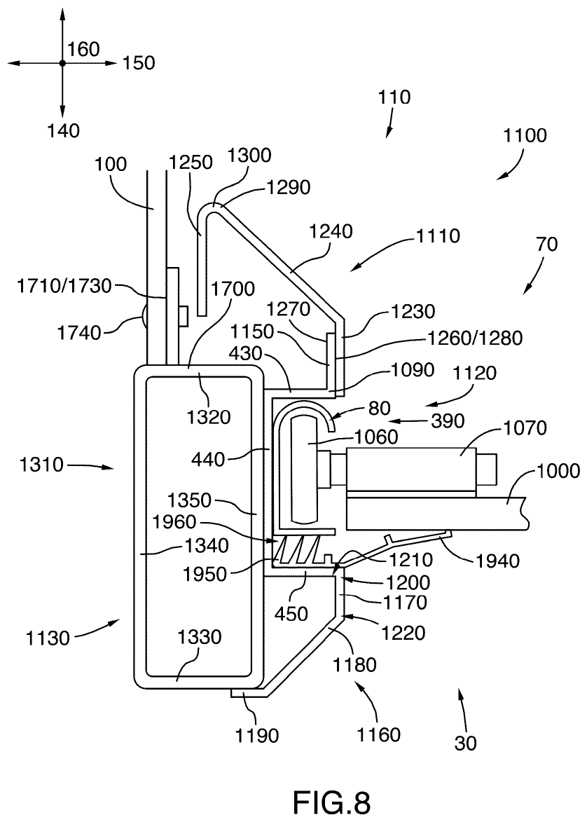

By way of example, in one aspect, as shown in FIG. 8, the box portion 1310 may be one piece, unitary, and integrally formed. The box portion 1310 may be generally rectangular, with the first short side 1320 and the second short side 1330 being planar and parallel one another and the first long side 1340 and the second long side 1350 being planar and parallel one another.

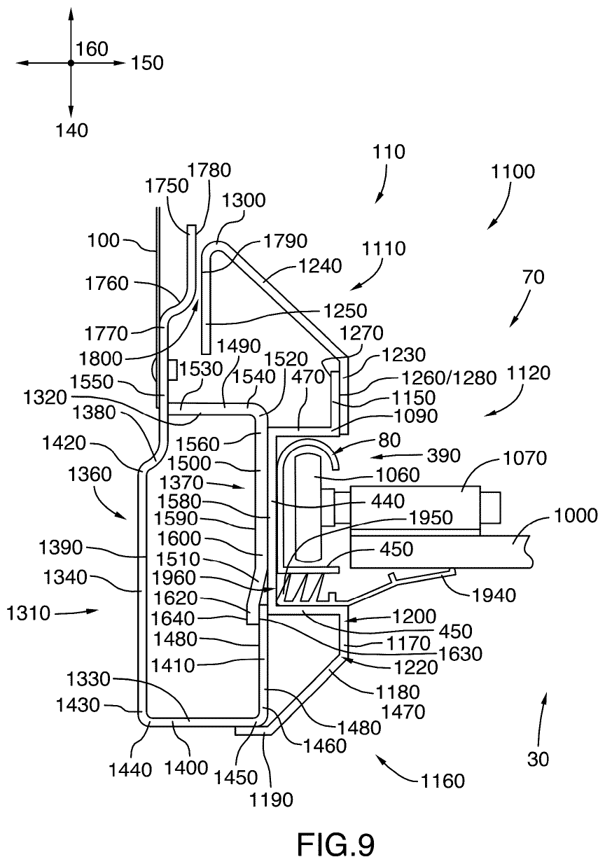

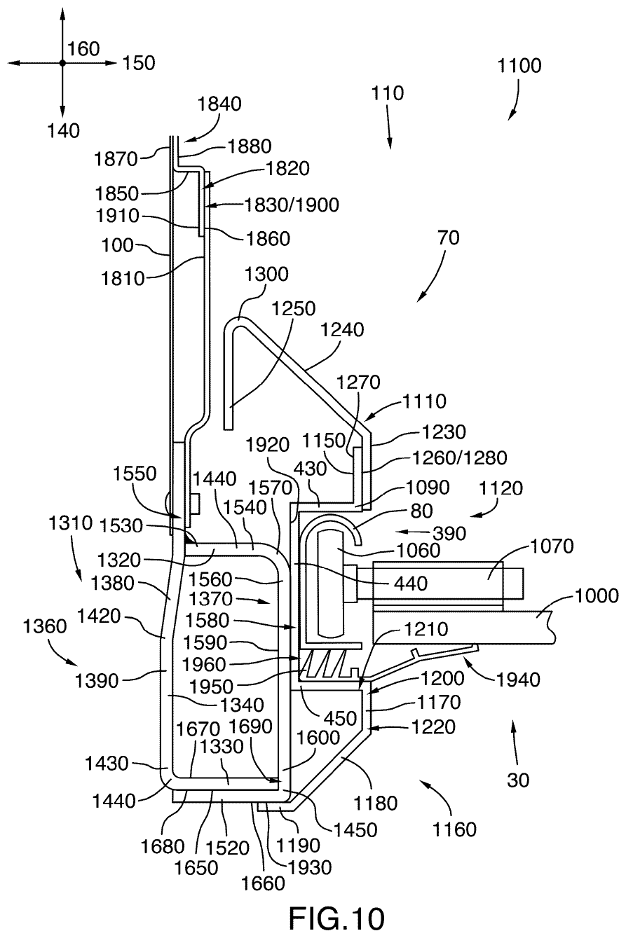

In another aspect, as shown in FIGS. 9-10, the box portion 1310 may comprise an outer portion 1360 and an inner portion 1370. The outer portion 1360 may be one piece, unitary, and integrally formed and may comprise a transition portion 1380 and a first leg 1390, a second leg 1400, and, in some aspects, a third leg 1410. The first leg 1390 may be generally parallel to the sidewall 100 and may extend longitudinally away from the sidewall 100 and may extend at least partially beyond the sidewall 100. By way of example, the entire first leg 1390 may be beyond the sidewall 100. The first leg 1390 may comprise a first end portion 1420 and a second end portion 1430.

The first leg 1390 of the outer portion 1360 may transition to a first end portion 1440 of the second leg 1400 of the outer portion 1360 at the second end portion 1430 of the first leg 1390. The second leg 1400 may extend laterally away from the first leg 1390 towards the opening 30 between the door post portions 1100. The outer portion 1360 may end at a second end portion 1450 of the second leg 1400, as shown in FIG. 10, or, as shown in FIG. 9, the second end portion 1450 of the second leg 1400 may transition to a first end portion 1460 of the third leg 1410.

The third leg 1410 may extend away from the second leg 1400 at an approximately 90-degree angle longitudinally towards the inside portion 110 of the trailer 10. In other words, the third leg 1410 may be generally perpendicular to the second leg 1400 and may not extend longitudinally beyond (i.e. further out of the trailer 10) than the second end portion 1430 of the first leg 1390. The third leg 1410 may be planar and may be generally parallel to the first leg 1390. A length of the third leg 1410 may be less than a length of the first leg 1390, and the third leg 1410 may comprise an inner surface portion 1470 and an outer surface portion 1480.

As shown in FIGS. 9 and 10, the inner portion 1370 may be one piece, unitary, and integrally formed. The inner portion 1370 may comprise a first portion 1490, a second portion 1500, in some aspects a connecting portion 1510, and in some aspects a third portion 1520.

The first portion 1490 of the inner portion 1370 may comprise a first end portion 1530 and a second end portion 1540. The first end portion 1530 may be in direct facing contact with an extension portion 1550 (discussed below). The first end portion 1530 may be attached to the extension portion 1550. The attachment may be achieved by any means necessary to secure the first end portion 1530 to the extension portion 1550, but by way of example, the attachment may be achieved via a weld, a snap fit, a form fit, and/or mechanical fasteners such as nuts, bolts, screws, and brackets. The first portion 1490 of the inner portion 1370 may be generally planar and may be generally parallel to the second leg 1400 of the outer portion 1360 of the box portion 1310.

The second end portion 1540 of the first portion 1490 of the inner portion 1370 may transition to a first end portion 1560 of the second portion 1500 of the inner portion 1370. The transition may be such as a radiused transition 1570. The second portion 1500 of the inner portion 1370 may extend away from the first portion 1490 of the inner portion 1370 towards the second leg 1400 of the outer portion 1360 at an approximately 90-degree angle. In other words, the second portion 1500 of the inner portion 1370 may be generally parallel to the first leg 1390 of the outer portion 1360 of the box portion 1310. The second portion 1500 of the inner portion 1370 may have an interior edge portion 1580 and an exterior edge portion 1590. The interior edge portion 1580 of the second portion 1500 may be co-planar with the inner surface portion 1470 of the third leg 1410 of the outer portion 1360.

A second end portion 1600 of the second portion 1500 of the inner portion 1370 may transition to the connecting portion 1510 of the inner portion 1370. The connecting portion 1510 may comprise a transition portion 1610 and a securing portion 1620. The transition portion 1610 may extend away from the second end portion 1600 of the second portion 1500 and towards the first leg 1390 of the outer portion 1360 at an angle of between approximately 100-degrees to approximately 140-degrees. The transition portion 1610 may be generally planar and may extend to the securing portion 1620.

The securing portion 1620 may comprise an inner surface portion 1630 and an outer surface portion 1640 and may extend away from the transition portion 1610 towards the second leg 1400 of the outer portion 1360. The securing portion 1620 may be laterally between and parallel to the first leg 1390 of the outer portion 1360 and the third leg 1410 of the outer portion 1360. The inner surface portion 1630 of the securing portion 1620 may be in direct facing contact with, and may be attached to, the outer surface portion 1480 of the third leg 1410 of the outer portion 1360. The attachment between the inner surface portion 1630 of the securing portion 1620 and the outer surface portion 1480 of the third leg 1410 of the outer portion 1360 may be achieved by any means necessary, but by way of example, the attachment may be achieved via a weld, a snap fit, a form fit, or mechanical fasteners such as nuts, bolts, screws, or brackets.

In another aspect, as shown in FIG. 10, the outer portion 1360 of the box portion 1310 may comprise only the first leg 1390 and the second leg 1400, and the inner portion 1370 of the box portion 1310 may comprise the third portion 1520. In such cases, the third portion 1520 of the inner portion 1370 may comprise an upper edge portion 1650 and a lower edge portion 1660. Further, the second leg 1400 of the outer portion 1360 may comprise an upper edge portion 1670, a lower edge portion 1680, and an inner edge portion 1690.

The lower edge portion 1680 of the second leg 1400 of the outer portion 1360 and the upper edge portion 1650 of the third portion 1520 of the inner portion 1370 of the box portion 1310 may be in direct facing contact with one another. The lower edge portion 1680 of the second leg 1400 of the outer portion 1360 may be attached to the upper edge portion 1650 of the third portion 1520 of the inner portion 1370. The attachment may be achieved via any means necessary, but by way of example, the attachment may be achieved via a weld, adhesives, form fitting, snap fitting, or mechanical fasteners such as nuts, bolts, screws, and brackets.

The inner edge portion 1690 of the second leg 1400 of the outer portion 1360 may be in direct facing contact with the exterior edge portion 1590 of the second portion 1500 of the inner portion 1370 of the box portion 1310. While direct facing contact is mentioned, a gap (not depicted) may exist between the inner edge portion 1690 of the second leg 1400 and the exterior edge portion 1590 of the second portion 1500.

The inner edge portion 1690 of the second leg 1400 of the outer portion 1360 may contact the exterior edge portion 1590 of the second portion 1500 of the inner portion 1370 simply as a result of the connection between the lower edge portion 1680 of the second leg 1400 and the upper edge portion 1650 of the third portion. In such a case, the inner edge portion 1690 of the second leg 1400 may rest against, without being attached to, the exterior edge portion 1590 of the second portion 1400 of the inner portion 1370. In another aspect, the inner edge portion 1690 of the second leg 1400 of the outer portion 1360 may be attached to the exterior edge portion 1590 of the second portion 1500 of the inner portion 1370. The attachment may be achieved by any means necessary, but by way of example, the attachment may be achieved via a weld, a form fit, a snap fit, and/or mechanical fasteners such as nuts, bolts, screws, and/or brackets.

The adaptor portion 1300 may further comprise the extension portion 1550. In one aspect, as shown in FIG. 8, the extension portion 1550 may extend perpendicularly from a central portion 1700 of the first short side 1320. The extension portion 1550 may be parallel to the side wall 100, and an outer portion 1710 of the extension portion 1550 may be in direct facing contact with an inner surface 1730 of the side wall 100. The extension portion 1550 may have a through hole (not depicted) that may align with a preexisting hole (not depicted) in the side wall 100. The through hole (not depicted) may be adapted to receive a mechanical fastener 1740, such as a bolt or a screw, which may also be received by the preexisting hole (not depicted) in the side wall 100 to secure the extension portion 1550, and thus the adaptor portion 1130, to the side wall 100. While a through hole (not depicted) and a preexisting hole (not depicted) are mentioned, it may be the case that neither the through hole or the preexisting hole are present, or it may be the case that the preexisting hole is made specifically for use with the door post portion 1100 at the time the door post portion 1100 is installed in the trailer 10.

In another aspect, as shown in FIG. 9 the adaptor portion 1130 may comprise the extension portion 1550 as previously described, and may further comprise a curved portion 1750 and an upper leg portion 1760. In the aspects shown in FIGS. 9 and 10, the extension portion 1550 may be one piece, unitary, and integrally formed with the first leg 1390 of the outer portion 1360 of the box portion 1310.

The curved portion 1750 may extend from an upper edge portion 1770 of the extension portion 1550. The curved portion 1750 may extend curvilinearly away from the sidewall 100 and towards the inside portion 110 of the trailer 10. The curved portion 1750 may transition into the upper leg portion 1760. The upper leg portion 1760 may extend towards the inside portion 110 of the trailer 10 and may be generally parallel to the sidewall 100 and to the second mating portion 1250 of the connecting portion 1110 of the door post portion 1110.

An inner portion 1780 of the upper leg portion 1760 may be in direct facing contact with an outer surface portion 1790 of the second mating portion 1250 of the connecting portion 1110. While a direct facing contact is mentioned, a gap 1800 may exist between the upper leg portion 1760 and the second mating portion 1250. The upper leg portion 1760 may be attached to the second mating portion 1250 such as via welding, adhesives, snap fitting, form fitting, and/or mechanical fasteners. While various methods are mentioned, the upper leg portion 1760 may be attached to the second mating portion 1250 via any means necessary to achieve the attachment, or there may be no attachment at all.

The upper leg portion 1760 may be cantilevered from the curved portion 1750 of the adaptor portion 1130, or as depicted in FIG. 10 an outer surface portion 1810 of the upper leg portion 1760 may contact an inner surface portion 1830 of a support portion 1820.

The support portion 1820 may be generally S shaped with a first portion 1840, a second portion 1850, and a third portion 1860. The first portion 1840 of the support portion 1820 may comprise an outer surface portion 1870 and an inner surface portion 1880. The outer surface portion 1870 may be in direct facing contact with the side wall 100 and may be generally parallel to the side wall 100.

The second portion 1850 of the support portion 1820 may extend perpendicularly from a primary end portion 1890 of the first portion 1840 of the support portion 1820 away from the side wall 100. The second portion 1850 may have a width that may match a summated lateral width of the extension portion 1550 and the curved portion 1750.

The second portion 1850 of the support portion 1820 may transition to the third portion 1860 of the support portion 1820. The third portion 1860 of the support portion 1820 may extend away from the second portion 1850 of the support portion 1820 at an approximately 90-degree angle. In other words, the third portion 1860 of the support portion 1820 may be generally perpendicular to the second portion 1850 of the support portion 1820. The third portion 1860 of the support portion 1820 may comprise an inner surface portion 1900 and an outer surface portion 1910. As previously stated, the inner surface portion 1830 of the support portion 1820 may be in direct facing contact with the outer surface portion 1810 of the upper leg 1760 of the adaptor portion 1130. The inner surface portion 1830 of the support portion 1820 and the outer surface portion 1810 of the upper leg 1760 may be attached to one another, if desired, by any means necessary to achieve an attachment, but by way of example, the attachment may be achieved via welding, snap fitting, form fitting, or mechanical fastening such as via, nuts, bolts, or screws.

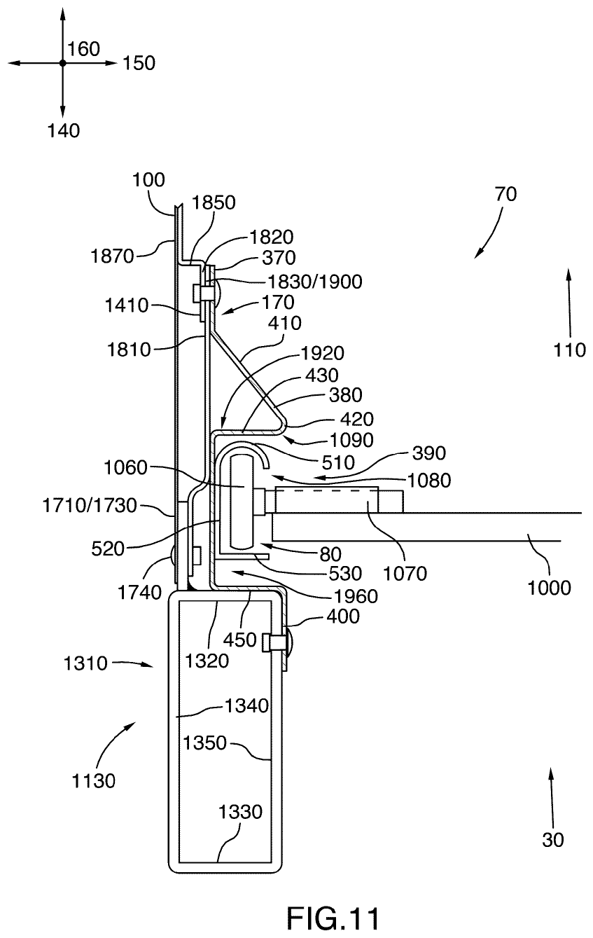

As shown in FIGS. 8-11, the door post portion 1100 may be connected to, such as attached to, the adaptor portion 1130. By way of example, at least a portion of an outer edge portion 1920 of the second wall 440 of the recessed portion 390 may be in direct facing contact with the interior edge portion 1580 of the second portion 1500 of the inner portion 1370 of the box portion 1310. While an attachment to the adaptor portion 1130 is mentioned, the door post portion 1100 may be attached to any lateral face on the inside of the trailer 10, such as the adaptor portion 1130 or the sidewall 100.

The attachment of the portion of the outer edge portion 1920 of the second wall 440 of the recessed portion 390 to the interior edge portion 1580 of the second leg 1400 of the inner portion 1370 may be achieved via any means necessary, but by way of example, the attachment may be achieved via a weld, form fitting, snap fitting, adhesives, and/or mechanical fasteners such as nuts, bolts, screws, and/or brackets.

In another aspect, the third portion 1860 of the second attachment portion 1160 of the housing portion 1120 of the door post portion 1100 may be attached to a lower surface portion 1930 of the second short side 1330 of the adaptor portion 1130. The attachment may be via any means necessary, but by way of example, the attachment may be achieved via a weld, form fitting, snap fitting, adhesives, and/or mechanical fasteners such as nuts, bolts, screws, and/or brackets.

The recessed portion 390 may be adapted to accommodate the track portion 80 as previously mentioned, and the track portion 80 may be adapted to accommodate the wheel 1060 or roller 1060 as previously mentioned.

In one aspect, as shown in FIGS. 8-10, a buffer portion 1940 may exist between the third wall of the recessed portion 390 and the track portion 80. The buffer portion may comprise at least one spike portion 1950 which may comprise a height. The height of the at least one spike portion 1950 may be generally equal to a height of a gap 1960 between the third wall 450 of the recessed portion 390 and the track portion 80.

It may be appreciated from the above description that the door post portion 1100 can be selectively inserted within a trailer 10 when the trailer 10 is manufactured, or the door post portion 1100 can be utilized to retrofit a trailer 10 that previously used swing open doors.

In accordance with the provisions of the patent statutes, the present device and/or method has been described in what is considered to represent its preferred embodiments. However, it should be noted that the present device and/or method can be practiced otherwise than as specifically illustrated and described without departing from its spirit or scope.
10 Trailer
20 Overhead Door
30 Opening
40 Door Post Portions
50 Vertical Opening
60 Offset Header
70 Overhead Door System
80 Track portion
90 Mounting Bracket
100 Side Walls
110 Trailer—Inside Portion
120 Trailer—End Portion
130 Trailer—Outside Portion
140 Longitudinal Extension
150 Lateral Extension
160 Vertical Extension
170 Door Post Portion—Inner door post portion
180 Door Post Portion—Outer door post portion
190 Outer door post portion—First Connector Portion
200 Outer door post portion—Long Portion
210 Outer door post portion—Width Portion
220 Outer door post portion—Second Connector Portion
230 First Connector Portion—First Long Leg
240 Attachment Location
250 Second Short Leg—First Connector Portion
260 First Radiused Corner
270 Long Portion—Inner Edge
280 Long Portion—Outer Edge
290 Second Radiused Corner
300 Second Connector Portion—First Portion
310 Second Connector Portion—Second Portion
320 Second Connector Portion—Third Portion
330 Second Connector Portion—First Portion—Outer Wall
340 Second Connector Portion—First Portion—Inner Wall
350 Second Connector Portion—Third Portion—Outer Wall
360 Second Connector Portion—Third Portion—Inner Wall
370 Inner door post portion—First Connector Portion
380 Inner door post portion—Bumper Portion
390 Inner door post portion—Recessed Portion
400 Inner door post portion—Second Connector Portion
410 Inner door post portion—Bumper Portion—Angled Edge
420 Third Radiused Corner
430 Recessed Portion—First Wall
440 Recessed Portion—Second Wall
450 Recessed Portion—Third Wall
460 Second Connector Portion—Inside Edge
470 Second Connector Portion—Outside Edge
480 Mounting Bracket
490 Mounting Bracket—First Leg
500 Mounting Bracket—Second Leg
510 Track—Upper Portion
520 Track—Middle Portion
530 Track—Lower Portion
540 Track—Upper Portion—Inner Portion
550 Track—Upper Portion—Outer Portion
560 Track—Upper Portion—Central Portion
570 Gap (Between Track and Mounting Bracket)
580 C-Shape (Formed by upper, middle, and lower portions)
590 Offset Header—First Portion/Lip
600 Offset Header—First Portion—Inner Wall
610 Offset Header—First Portion—Outer Wall
620 Trailer—Top Portion
630 Connecting Sheet
640 Trailer—Top Portion—Short Edge
650 Trailer—Top Portion—Long Edge
660 Offset Header—First Portion—End Portion
670 Offset Header—First Portion—Top Portion
680 Offset Header—First Portion—Bottom Portion
690 Offset Header—Second Portion
700 Offset Header—Second Portion—Inner Wall
710 Offset Header—Second Portion—Outer Wall
720 Offset Header—Second Portion—Upper End Portion
740 Trailer—Top Portion—Short Edge—Outer Surface
750 Vertical Offset
760 Offset Header—Sealing Portion
770 Offset Header—Sealing Portion—Horizontal Portion
780 Offset Header—Second Portion—Lower End Portion
790 Offset Header—Sealing Portion—Horizontal Portion—Inner Wall
800 Offset Header—Sealing Portion—Horizontal Portion—Outer Wall
810 Offset Header—Sealing Portion—Vertical Portion
820 Offset Header—Sealing Portion—Vertical Portion—Inner Wall
830 Offset Header—Sealing Portion—Vertical Portion—Outer Wall
840 Offset Header—Sealing Portion—Horizontal Portion—End
850 Offset Header—Sealing Portion—Seal
860 Offset Header—Third Portion
870 Offset Header—Third Portion—First End Portion
880 Offset Header—Sealing Portion—Vertical Portion—End Portion
890 Offset Header—Third Portion—Inner Wall
900 Offset Header—Third Portion—Outer Wall
910 Offset Header—Fourth Portion
920 Offset Header—Fourth Portion—Inner Wall
930 Offset Header—Fourth Portion—Outer Wall
940 Offset Header—Fourth Portion—First End Portion
950 Offset Header—Third Portion—Second End Portion
960 Offset Header—Fifth Portion
970 Offset Header—Fifth Portion—Inner Wall
980 Offset Header—Fifth Portion—Outer Wall
990 Offset Header—Fourth Portion—Second End Portion
1000 Overhead Door—Panel
1010 Overhead Door—Top Panel
1020 Overhead Door—Top Panel—Horizontal Position
1030 Overhead Door—Top Panel—Vertical Position
1040 Overhead Door—Top Panel—Upper Edge Portion
1060 Wheel/Roller
1070 Axles
1080 Track portion—Opening
1090 First Wall—First Edge Portion
1100 Door post portion
1110 Connecting Portion
1120 Housing Portion
1130 Adaptor Portion
1140 Opening
1150 Housing Portion—First Attachment Portion
1160 Housing Portion—Second Attachment Portion
1170 Housing Portion—Second Attachment Portion—First Portion
1180 Housing Portion—Second Attachment Portion—Second Portion
1190 Housing Portion—Second Attachment Portion—Third Portion
1200 Housing Portion—Second Attachment Portion—First Portion—First Edge Portion
1210 Recessed Portion—Third Wall—First Edge Portion
1220 Housing Portion—Second Attachment Portion—First Portion—Second Edge Portion
1230 Connecting Portion—First Mating Portion
1240 Connecting Portion—Transition Portion
1250 Connecting Portion—Second Mating Portion
1260 First Mating Portion—Inner Surface Portion
1270 First Mating Portion—Outer Surface Portion
1280 Housing Portion—First Attachment Portion—Outer Surface Portion
1290 Transition Portion—Outer Edge Portion
1300 Radiused Corner (Transition Portion and Second Mating Portion)
1310 Adaptor Portion—Box Portion
1320 Box Portion—First Short Side
1330 Box Portion—Second Short Side
1340 Box Portion—First Long Side
1350 Box Portion—Second Long Side
1360 Box Portion—Outer Portion
1370 Box Portion—Inner Portion
1380 Box Portion—Outer Portion—Transition Portion
1390 Box Portion—Outer Portion—First Leg
1400 Box Portion—Outer Portion—Second Leg
1410 Box Portion—Outer Portion—Third Leg
1420 Box Portion—Outer Portion—First Leg—First End Portion
1430 Box Portion—Outer Portion—First Leg—Second End Portion
1440 Box Portion—Outer Portion—Second Leg—First End Portion
1450 Box Portion—Outer Portion—Second Leg—Second End Portion
1460 Box Portion—Outer Portion—Third Leg—First End Portion
1470 Box Portion—Outer Portion—Third Leg—Inner Surface Portion
1480 Box Portion—Outer Portion—Third Leg—Outer Surface Portion
1490 Box Portion—Inner Portion—First Portion
1500 Box Portion—Inner Portion—Second Portion
1510 Box Portion—Inner Portion—Connecting Portion
1520 Box Portion—Inner Portion—Third Portion
1530 Box Portion—Inner Portion—First Portion—First End Portion
1540 Box Portion—Inner Portion—First Portion—Second End Portion
1550 Adapter Portion—Extension Portion
1560 Box Portion—Inner Portion—Second Portion—First End Portion
1570 Radiused Transition (between 1560 and 1540.
1580 Box Portion—Inner Portion—Second Portion—Interior Edge Portion
1590 Box Portion—Inner Portion—Second Portion—Exterior Edge Portion
1600 Box Portion—Inner Portion—Second Portion—Second End Portion
1610 Box Portion—Inner Portion—Connecting Portion—Transition Portion
1620 Box Portion—Inner Portion—Connecting Portion—Securing Portion
1630 Box Portion—Inner Portion—Connecting Portion—Securing Portion—Inner Surface Portion
1640 Box Portion—Inner Portion—Connecting Portion—Securing Portion—Outer Surface Portion
1650 Box Portion—Inner Portion—Third Portion—Upper Edge Portion
1660 Box Portion—Inner Portion—Third Portion—Lower Edge Portion
1670 Box Portion—Outer Portion—Second Leg—Upper Edge Portion
1680 Box Portion—Outer Portion—Second Leg—Lower Edge Portion
1690 Box Portion—Outer Portion—Second Leg—Inner Edge Portion
1700 First Short Side—Central Portion
1710 Adaptor Portion—Extension Portion—Outer Portion
1720 Side Wall—Inner Surface
1730 Adaptor Portion—Extension Portion—Inner Surface
1740 Mechanical Fastener for Extension Portion
1750 Adaptor Portion—Extension Portion—Curved Portion
1760 Adaptor Portion—Extension Portion—Upper Leg Portion
1770 Adaptor Portion—Extension Portion—Upper Edge Portion
1780 Adaptor Portion—Extension Portion—Upper Leg Portion—Inner Portion
1790 Connecting Portion—Second Mating Portion—Outer Surface Portion
1800 Gap Between Upper Leg Portion and Second Mating Portion
1810 Adaptor Portion—Extension Portion—Upper Leg Portion—Outer Surface Portion
1820 Support Portion
1830 Support Portion—Inner Surface Portion
1840 Support Portion—First Portion
1850 Support Portion—Second Portion
1860 Support Portion—Third Portion
1870 Support Portion—First Portion—Outer Surface Portion
1880 Support Portion—First Portion—Inner Surface Portion
1890 Support Portion—First Portion—Primary End Portion
1900 Support Portion—Third Portion—Inner Surface Portion
1910 Support Portion—Third Portion—Outer Surface Portion
1920 Recessed Portion—Second Wall—Outer Edge Portion
1930 Adaptor Portion—Box Portion—Second Short Side—Lower Surface Portion
1940 Buffer Portion
1950 Spike Portion
1960 Gap Between Thid Wall of Recessed Portion and Track portion

What is claimed is:

1. An overhead door system, comprising:
at least one door post portion,
wherein said at least one door post portion comprises a recessed portion with a track portion.

2. The overhead door system of claim 1, wherein the door post portion is connected to a side wall of a trailer.

3. The overhead door system of claim 1, wherein an upper portion of the track portion is attached to a first wall of the recessed portion.

4. The overhead door system of claim 1, wherein said recessed portion comprises a mounting bracket.

5. The overhead door system of claim 4, wherein said mounting bracket is attached to a second wall and a third wall of said recessed portion.

6. The overhead door system of claim 4, wherein a middle portion and a lower portion of the track portion are attached to the mounting bracket.

7. The overhead door system of claim 1, further comprising a header, wherein said header comprises a sealing portion with a sealing surface, and wherein said sealing surface is adapted to seal with a door.

8. The overhead door system of claim 7, wherein when the door is in a closed position, upward movement of the door is blocked by a horizontal portion of the header.

9. An overhead door system comprising:
at least one door post portion,
wherein said at least one door post portion comprises a recessed portion and a bumper portion.

10. The overhead door system of claim 9, wherein the recessed portion is longitudinally between a bumper portion and a width portion of the at least one door post portion.

11. The overhead door system of claim 10, wherein the at least one door post portion comprises an inner door post portion and an outer door post portion.

12. The overhead door system of claim 11, wherein the inner door post portion comprises the bumper portion and the recessed portion, and the outer door post portion comprises the width portion.

13. The overhead door system of claim 12, comprising two door post portions with an opening between the door post portions.

14. The overhead door system of claim 13, wherein the width portion extends laterally further into the opening than the bumper portion.

15. The overhead door system of claim 9, wherein a door is adapted to move within the recessed portion of the at least one door post portion.

16. An overhead door system comprising:
at least one door post portion,
wherein said at least one door post portion comprises a housing portion and a connecting portion,
wherein said housing portion comprises a recessed portion.

17. The overhead door system of claim 16, wherein the recessed portion may comprise a first wall, a second wall, and a third wall.

18. The overhead door system of claim 16, further comprising an adaptor portion, wherein said adaptor portion is connected to a lateral face of the inside of a trailer.

19. The overhead door system of claim 18, wherein at least a portion of the recessed portion is in direct facing contact with at least a portion of the adaptor portion.

20. The overhead door system of claim 16, wherein the overhead door system may further comprise a door which may be movable within the at least one door post portion.
